(19) United States
(12) Patent Application Publication
(10) Pub. No.: US 2004/0185934 A1
(43) Pub. Date: Sep. 23, 2004

(54) Game cotroller with an alarm clock

(75) Inventor: Chi-Fu Peng, Chungli City (TW)

Correspondence Address: BACON & THOMAS, PLLC, 625 SLATERS LANE, FOURTH FLOOR, ALEXANDRIA, VA, 22314

(73) Assignee: VISION ELECTRONICS CO., LTD., Chungli City (TW)

(21) Appl. No.: 10/393,043

(22) Filed: Mar. 21, 2003

(51) Int. Cl. A63F 13/00

(52) U.S. Cl. 463/36

(57) ABSTRACT

A game controller with an alarm clock comprising a control circuit, a sound chip, an amplifier, a communication interface, a plurality of buttons and a time setting button is provided. The sound chip is capable of generating a continuous sound frequency in response to a signal from the control circuit, and transmits the sound frequency to the amplifier for outputting the sound. The communication interface connects the game controller and the game system. The plurality of the buttons is electrically connected to the control circuit for the user to input control signal during the functioning of the game software of the game system. And the time setting button is electrically connected to the control circuit to enable the user to switch on or off the alarm clock. The time setting button is also electrically in contact with any one of plurality of buttons on the game controller to enable the use to set the time.

### BACKGROUND OF THE INVENTION

1. The Field of the Invention

The present invention relates to a game controller with alarm clock, and more particularly to a game system, which activates a alarm clock that is built in the control circuit of the game controller when the game program is executed, and when a preset time set in the clock circuit is reached, the control circuit outputs a signal to a sound chip and/or a vibration device to output an alarm as a notifying signal to the user.

2. Description of the Related Art

In the present rapid technological development era, new game systems and the one to coordinate with the new game software also been provided day by day by the manufacturers for meeting the requirement of the consumers. Accordingly, the game contents, and the sound and visional effects, are also being improved to be more and more interesting and exciting, as a result, this can easily make the user forget about the time while playing the game. Besides, the user usually stares at the monitor too much during the game ignoring the time for ending the game. This causes to miss the time for taking care of other jobs.

Referring to FIG. 4, show a view of a conventional circuit diagram of a game controller A10 comprising a control circuit A11, a communication interface A14, a plurality of buttons A15 and a vibration device A18. The communication interface A14 is for connecting the game controller A10 and the game system A17. A plurality of buttons A15 are electrically connected to the control circuit A11 allowing a user to input control signals while operating the game software and also to command the game system A17 to run the game software. The vibration device A18 is connected to the control circuit A11 to enable the control circuit A11 to activate the vibration device A18. Thus when the user in a game situation such as being hit by bullets during a shooting game or a plane crushing during a flying game, the control circuit A11 will activate the vibration device A18 to vibrate the game controller A10 to provide a realistic feeling to the user.

The game controllers available in the market are designed to vibrate the game controller in some situations of the game and also have other functions, for example, program, turbo, slow, auto fire and others. Some game controllers even can work with extended earphone and microphone to enable the users of the internet game can talk to other users while playing. However, game controllers of the prior art do not have alarm clock to remind the user of the time. Therefore, the user will easily lose track of time while playing the game and miss to attain to important things, such as homework, date, dinning and sleep. This also further cause social problems to the user or the user's family and friends, and may also lead to user's addiction to playing games. Therefore it is highly desirable to design a new game controller for solving the time-ignoring problems in order to resolve the aforementioned problems.

### SUMMARY OF THE INVENTION

Accordingly, in the view of the foregoing, the present inventors make a detailed study of related art to evaluate and consider, and uses years of accumulated experience in this field, and through several experiments, to create a new game controller. The present invention provides an innovated game controller with an alarm clock to effectively notify the game time to the user in order to resolve the aforementioned problems of the prior art.

According to one purpose of the present invention, a time setting button is provided on the game controller, so that the user can use this time setting button to input the function of switching on or off the alarm clock, and a plurality of buttons on the game controller, wherein any one of said plurality of buttons is electrical connected between with the time setting button for allowing the user for inputting preset time in the alarm clock.

According to another purpose of the present invention, the game controller is provided with the alarm clock that can coordinate with the game system, particularly the game system, which can run various game programs. When the game system starts to execute the game program, the alarm clock in the control circuit of the game controller will be activated, and when the preset time is reached/lapsed, the controller circuit will output a signal to a sound chip to output sound music through an amplifier to notify the user.

According to yet another purpose of the present invention, the game controller is provided with a vibration device. When the game system executes the game program, the alarm clock in the control circuit of the game controller will be activated, and when the preset time is reached the controller circuit will output a signal to activate the vibration device to vibrate in order to notify the user.

In accordance with the above purposes of the present invention, in the above embodiments of the game controller with alarm clock of the present invention, especially the one with the sound chip and the amplifier, the control circuit transmits a signal to the sound chip to activate the sound chip to output a sound music through the amplifier for notifying the user of time. Thus this invention not only overcomes the inconvenience of having no alarm clock but also allows the user to play the game more comfortably with the sense of time, such as TV game. Therefore the user will have more interest to play because of the time notification means.

### BRIEF DESCRIPTION OF THE DRAWINGS

For a more complete understanding of the present invention, reference will now be made to the following detailed description of preferred embodiments taken in conjunction with the accompanying drawings, in which:

FIG. 1 is a perspective view of a game controller of the present invention;

FIG. 2 is a circuit block diagram showing the operation of the game controller of the present invention;

FIG. 3 is a circuit diagram of the game controller of the present invention; and

FIG. 4 is a circuit block diagram showing the operation of a convention game controller.

### DETAILED DESCRIPTION OF THE PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

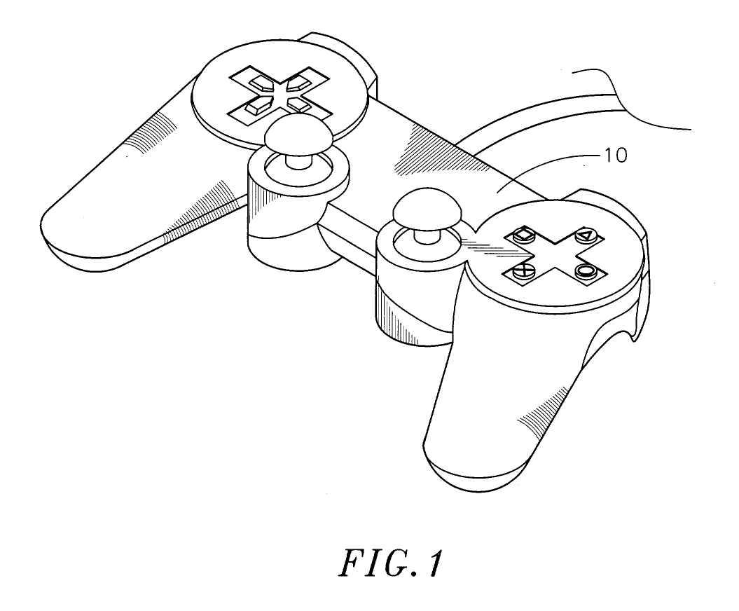

Referring to FIGS. 1, 2 and 3, the game controller 10, particularly the one that can coordinate with a game system 17, comprises a control circuit 11, a sound chip 12, an amplifier 13, a communication interface 14, a plurality of buttons 15 and a time setting button 16. The control circuit 11 controls the sound chip 12. The sound chip 12 has a capability of generating a continuous sound frequency in response to a signal it receives from the control circuit 11, and transmits the sound frequency to the amplifier 13 for outputting the sound. The communication interface 14 connects the game controller 10 and the game system 17. The plurality of the buttons 15 is electrically connected to the control circuit 11 for the user to input control signal during the functioning of the game software of the game system 17. And the time setting button 16 is electrically connected to the control circuit 11 to enable the user to switch on or off the alarm clock. The time setting button 16 is also electrically in contact with any one of plurality of buttons 15 on the game controller 10 to enable the use to set the time.

However, if the user forgets to use time setting button 16 to switch on the alarm clock, the control circuit 11 of the game controller 10 of the present invention can start timing automatically by a built-in clock circuit, when the preset time is reached, the control circuit 11 will output a signal to the sound chip 12, which causes the sound chip 12 to generate continuous sound or music frequency and output sound or music through the amplifier 13 to notify the user of the preset time.

The game controller 10 of the present allows the user can use the time setting button 16 to set the alarm clock, so when the game system 17 executes the game program, the built-in clock circuit of the control circuit 11 is activated and begins to time the game, and when the preset time is reached, the control circuit 11 outputs a signal to the sound chip 12 which causes the sound chip 12 to generate sound or music and output a sound or music through the amplifier 13 to notify the user of the preset time.

As shown in FIGS. 1, 2 and 3, the game controller 10 comprises a vibration device 18. The vibration device 18 comprises a motor, and a biasing axle block (not shown) covering the axle of the motor. When the preset time is reached, the control circuit 11 outputs a signal to the sound chip 12, which causes the vibration device 18 to generate a continuous sound or music frequency and output a sound or music through the amplifier 13, and also causes the vibration device 18 to vibrate, to notify the user. Thus the vibration device 18 of the present invention has a capability to notify the preset time to the user by generating sound, music and/or vibration.

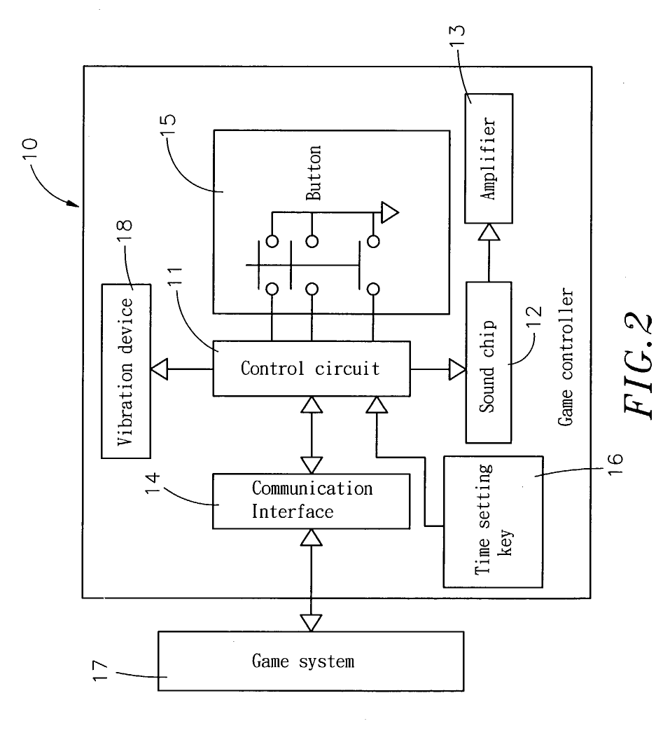

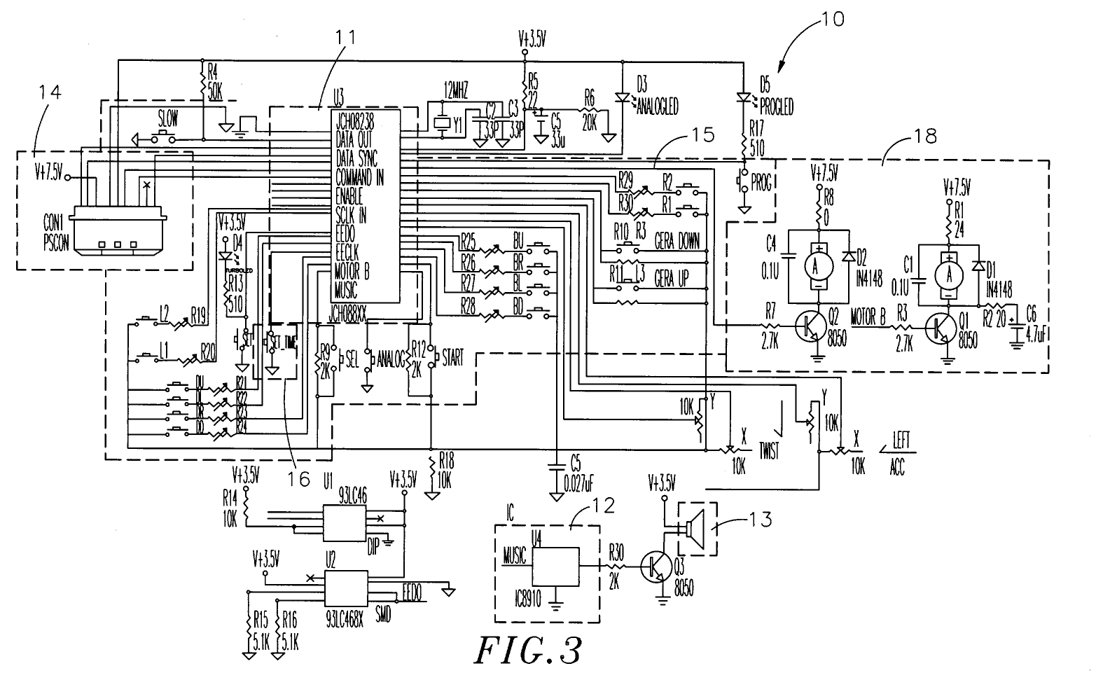

Referring to FIGS. 2 and 3 again, the control circuit 11 may be comprised of a chip, when the preset time is due, the control circuit 11 outputs a signal to the sound chip 12 which causes the sound chip 12 to generate a continuous sound or music frequency and output a sound or music through the amplifier 13 to notify the user of the preset time.

As shown in FIGS. 2 and 3, the communication interface 14 may be a wired communication interface or a wireless communication interface, for communicating with the game system 17 through a data transmission cable or wirelessly.

Accordingly, after playing the game for some time (preset time) using the game system 17, the user will receive a notification to quit the game from the game controller 10. Therefore the user will not forget or ignore the time for taking care of other important matters.

The game system 17 may be a TV, computer game or the like products.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A game controller with an alarm clock, comprising:
a control circuit;
a sound chip, controlled by said control circuit, for generating a continuous sound or music frequency in response to a signal received from said control circuit and output said sound or music frequency to an amplifier to output a sound or music, wherein the amplifier can be controlled by said control circuit;
a communication interface, allowing communication between said game controller and a game system;
a plurality of buttons, electrically connected to said control circuit, allowing a user to input control signal while playing the game and commanding said game system to execute the commands to a game software; and
a time setting button, electrically connected to said control circuit, allowing the user to switch on or off the alarm clock, and electrically connected with any one of preset buttons on said game controller allowing the user to use the button on said game controller to set the alarm clock, wherein when said game system executes said game program, a built-in clock circuit in said control circuit begins to time the game, and when the preset time is reached, said control circuit outputs a signal to said sound chip to generate a continuous sound or music frequency and output the sound or music through said amplifier to notify the user.

2. The game controller with an alarm clock according to claim 1, wherein said game controller comprises a vibration device, when the preset time in said control circuit of said controller has lapsed, said control circuit outputs a signal to said sound chip to generate a continuous sound or music frequency and output the sound or music through said amplifier, and rotate said vibration device to make a biasing axle covered on said vibration device to vibrate to generate a vibration, to notify the user.

3. The game controller with an alarm clock according to claim 1, wherein said control circuit is comprised of a chip.

4. The game controller with an alarm clock according to claim 1, wherein said communication interface is a wired communication interface in communication with said game system using a data transmission cable.

5. The game controller with an alarm clock according to claim 1, wherein said communication interface is a wireless communication interface in communication with said game system using a wireless data transmission method.

6. A game controller with an alarm clock comprising:
a control circuit;
a communication interface, allowing communication between said game controller and a game system;
a plurality of buttons, electrically connected to said control circuit, allowing a user to input control signal while playing the game and to command said game system to execute the commands to the game software; and
a time setting button, electrically connected to said control circuit, allowing the user to switch on or off the alarm clock, and electrical connected to any one of preset buttons on said game controller to enable a user to use the button to set the alarm clock; and
a vibration device, electrically connected to said control circuit, said control circuit can control said vibration device, wherein when said game system executes said game program, a built-in clock circuit in said control circuit begins to time the game, and when the preset time is reached, said control circuit outputs a signal to said vibration device to rotate and generate a regular vibration to notify the user.

7. The game controller with an alarm clock according to claim 6, wherein said control circuit is comprised of a chip.

8. The game controller with an alarm clock according to claim 6, wherein said communication interface is a wired communication interface in communication with said game system using a data transmission cable.

9. The game controller with an alarm clock according to claim 6, wherein said communication interface is a wireless communication interface in communication with said game system using a wireless data transmission method.

10. The game controller with an alarm clock according to claim 1 or 6, wherein if said clock is not turned on through said time setting button, said built-in clock circuit in said control circuit of said controller will time the game automatically.

11. The game controller with an alarm clock according to claim 1 or 6, wherein said game controller comprises a vibration device with a motor and a biasing axle on said motor.
